(19) United States
(12) Patent Application Publication
(10) Pub. No.: US 2021/0269653 A1
(43) Pub. Date: Sep. 2, 2021

(54) AQUEOUS DISPERSIONS AND EMULSION PAINTS COMPRISING ETHYLHEXYL ACRYLATE-BUTYL ACRYLATE-STYRENE COPOLYMERS

(71) Applicant: BASF SE, Ludwigshafen am Rhein (DE)

(72) Inventors: Martin Robert SCHEUBLE, Ludwigshafen am Rhein (DE); Ivan CABRERA, Ludwigshafen am Rhein (DE); Immanuel WILLERICH, Ludwigshafen am Rhein (DE); Crispin AMIRI NAINI, Ludwigshafen am Rhein (DE); Nicolas TISSIER, Ludwigshafen am Rhein (DE); Joerg Alexander DIMMER, Shanghai (CN); Tanja ROST, Ludwigshafen am Rhein (DE)

(21) Appl. No.: 17/256,431

(22) PCT Filed: Jun. 19, 2019
(86) PCT No.: PCT/EP2019/066242

§ 371 Date: Dec. 28, 2020

(30) Foreign Application Priority Data
Jun. 28, 2018 (EP) 18180397.4

(51) Int. Cl. C09D 5/02; C09D 7/61; C08F 212/08; C08F 220/06; C08F 220/18; C08F 230/08; C08F 2/22; C08K 3/013; C08K 3/34; C08L 33/08

(52) U.S. Cl. CPC C09D 5/022; C09D 5/028; C09D 7/61; C08F 212/08; C08F 220/06; C08F 220/1804; C08L 2205/18; C08F 230/085; C08F 2/22; C08K 3/013; C08K 3/34; C08L 33/08; C08L 2201/54; C08F 220/1808

(57) ABSTRACT

The present invention relates to an aqueous emulsion paint comprising
a) 5% to 50% by weight of an aqueous polymer dispersion having a solids content in the range from 40% to 60% by weight, obtainable by the free-radical aqueous emulsion polymerization of a monomer mixture comprising ethylhexyl acrylate, butyl acrylate and one or more vinylaromatics, preferably styrene,
b) 0.1% to 5% by weight of alkali metal alkylsiliconate and/or water-soluble silicate,
c) 20% to 70% by weight of inorganic fillers,
d) 0% to 30% by weight of at least one pigment,
e) 0.1% to 10% by weight of customary auxiliaries, and
f) water,
   based in each case on the total amount of the emulsion paint, the pH of the emulsion paint having a value in the range from 10 to 12, and also relates to the aqueous polymer dispersions, to a process for the preparation thereof and to the use thereof as organic binders in emulsion paints having a high pH.

The present invention relates to aqueous dispersions and emulsion paints, in particular interior paints, comprising ethylhexyl acrylate-butyl acrylate-styrene copolymers as binders, to a process for preparing the aqueous dispersion and the emulsion paint, to the use of the aqueous emulsion paint and to the use of ethylhexyl acrylate-butyl acrylate-styrene copolymers as binders for basic aqueous emulsion paints.

The coating of substrates is often effected using two-component silicate paints or using single-component silicate emulsion paints in accordance with DIN 18363, which in addition to waterglass and waterglass-resistant pigment also comprise up to 5% by weight of organic constituents, based on the total amount of silicate emulsion paint. Organic constituents used are typically synthetic resin dispersions.

Emulsion paints comprising polymer dispersions as binders are advantageous due to their easier handling. In order to ensure sufficient storage stability, dispersions and emulsion paints usually comprise preservatives and/or biocides. It is therefore an aim to make available a biocide-free dispersion and emulsion paint.

WO 02/0078 describes a preservative-free emulsion paint comprising a polymer dispersion as organic binder, pigment and/or filler and also up to 2% by weight of waterglass as inorganic binder. Polymer dispersions mentioned are polystyrene acrylates and various monomer classes are listed only generally. The polymeric binders are often not stable over the long term at high pH, which also has effects on the emulsion paint.

DE 10 2014 013 455 and WO2017/144694 teach preservative-free emulsion paints which have a high pH and to which alkali metal alkylsiliconates have in addition been added. This document also teaches straight acrylate or polystyrene acrylate as polymer dispersions, and various monomer classes only in a very general manner.

An object of the invention was to find an emulsion paint the binder polymers of which have a good storage stability even at high pH. There was also a search for a dispersion having a high pH in which the physical properties such as pH, viscosity and stability of the dispersion or of the paint do not change for the longest possible period.

The object is achieved according to the invention by an aqueous emulsion paint comprising
a) 5% to 50% by weight, preferably 8-30% by weight, of an aqueous polymer dispersion having a solids content in the range from 40% to 60% by weight, obtainable by the free-radical aqueous emulsion polymerization of a monomer mixture comprising ethylhexyl acrylate, butyl acrylate and one or more vinylaromatics, preferably styrene,
b) 0.1% to 5% by weight of alkali metal alkylsiliconate (solid) and/or water-soluble silicate (solid),
c) 20% to 70% by weight of inorganic fillers,
d) 0% to 30% by weight of at least one pigment,
e) 0.1% to 10% by weight of customary auxiliaries, and
f) water,
   based in each case on the total amount of the emulsion paint, the pH of the emulsion paint having a value in the range from 10 to 12, preferably 10.5 to 12, particularly preferably 11 to 12.

The invention further comprises aqueous dispersions, a process for preparing same, and the use of same as organic binders in emulsion paints having a high pH.

According to the invention, 5% to 50% by weight, preferably 8% to 30% by weight and in particular 10% to 20% by weight, of an aqueous polymer dispersion (component a) having a solids content in the range from 40% to 60% by weight, obtainable by the free-radical aqueous emulsion polymerization of a monomer mixture comprising ethylhexyl acrylate, butyl acrylate and one or more vinylaromatics, is used.

The binder polymer present in the polymer dispersion used according to the invention comprises, in copolymerized form,
10 to 30 parts by weight, preferably 12 to 20 parts by weight, based on the total monomers, of ethylhexyl acrylate,
25 to 50 parts by weight, preferably 30 to 45 parts by weight, based on the total monomers, of butyl acrylate
30 to 50 parts by weight, preferably 35 to 45 parts by weight, based on the total monomers, of one or more vinylaromatics,
0 to 10 parts by weight, preferably 0.1 to 5 parts by weight, based on the total monomers, of one or more monomers selected from among sulfonic acids, carboxylic acids, the alkali metal or ammonium salts thereof, carboxylic anhydrides, amides and hydroxyalkyl esters, and
0 to 10 parts by weight, preferably 0.1 to 5 parts by weight, based on the total monomers, of other monomers,
the sum total of all monomers amounting to 100 parts by weight.

As ethylhexyl acrylate, 2-ethylhexyl acrylate is preferably suitable according to the invention.

As butyl acrylate, n-butyl acrylate, isobutyl acrylate, sec-butyl acrylate and n-butyl acrylate are suitable according to the invention. Preference is given to n-butyl acrylate.

Suitable vinylaromatics are styrene, α-methylstyrene, o- or p-vinyltoluene. Preference is given to using styrene.

The polymer can further be formed, that is to say the monomer mixture comprise up to 10 parts by weight, preferably 0.1 to 5 parts by weight, based on the total monomers, of one or more monomers selected from among sulfonic acids, carboxylic acids, the alkali metal or ammonium salts thereof, carboxylic anhydrides, amides and hydroxyalkyl esters. Examples which may be mentioned include monoethylenically unsaturated alkyl- or arylsulfonic acids such as vinylsulfonic acid, methallylsulfonic acid, vinylbenzenesulfonic acid, acrylamidoethanesulfonic acid, acrylamidopropanesulfonic acid, 2-sulfoethyl (meth)acrylate, sulfopropyl (meth)acrylate and α,β-unsaturated C₃-C₆ carboxylic acids, α,β-unsaturated C₄-C₈ dicarboxylic acids, or their anhydrides, such as acrylic acid, methacrylic acid, crotonic acid, fumaric acid, maleic acid, maleic anhydride, itaconic acid and itaconic anhydride, and also the alkali metal or ammonium salts of the monomers mentioned, in particular the sodium salts thereof. Furthermore suitable are the amides and the hydroxyalkyl esters of α,β-unsaturated C₃-C₆ carboxylic acids, preferably acrylamide, methacrylamide, 2-hydroxyethyl acrylate, 2-hydroxyethyl methacrylate, 2-hydroxypropyl (meth)acrylate or butane-1,4-diol monoacrylate. These monomers are monomers having stabilizing groups.

The monomer mixture may furthermore comprise monomers comprising siloxane groups, preferably in an amount of from 0.01 to 5 parts by weight, preferably 0.01 to 2 parts by weight, based on the total monomers. Suitable monomers comprising siloxane groups are for example vinyltrialkoxysilanes, for example vinyltrimethoxysilane, vinyltriethoxysilane, alkylvinyldialkoxysilanes or (meth)acryloxyalkyltrialkoxysilanes, for example (meth)acryloxyethyltrimethoxysilane, (meth)acryloxypropyltrimethoxysilane or mixtures thereof. Particular preference is given to aqueous polymer dispersions the monomer mixture of which comprises (meth)acryloxyalkyltrialkoxysilanes, preferably in an amount of from 0.01 to 5 parts by weight, in particular 0.01 to 2 parts by weight, based on the total monomers.

In addition to the mentioned monomers ethylhexyl acrylate, butyl acrylate, vinylaromatics and the above-mentioned monomers having stabilizing groups, and also monomers comprising siloxane groups, the binder polymers according to the invention may also comprise further ethylenically unsaturated monomers in copolymerized form in an amount of up to 10 parts by weight, based on the binder polymer. Up to 10 parts by weight of these other monomers may therefore be present in the monomer mixture. The monomer mixture preferably comprises up to 5 parts by weight of other monomers.

According to a preferred embodiment, the monomer mixture consists of ethylhexyl acrylate, butyl acrylate, vinylaromatics and one or more monomers selected from among sulfonic acids, carboxylic acids, the alkali metal or ammonium salts thereof, carboxylic anhydrides, amides and hydroxyalkyl esters and optionally one or more monomers comprising siloxane groups.

Suitable other monomers are for example branched and unbranched, ethylenically unsaturated C₃-C₁₀ olefins, ethyl acrylate, n-propyl acrylate, n-hexyl acrylate, 2-ethylhexyl methacrylate, or 2-propylheptyl acrylate, C₅-C₁₀-alkyl methacrylates such as n-hexyl methacrylate and 2-ethylhexyl methacrylate, C₅-C₁₀-cycloalkyl (meth)acrylates, C₁-C₁₀-dialkyl maleates and/or C₁-C₁₀-dialkyl fumarates.

Suitable other monomers are also, for example, vinyl chloride, vinylidene chloride, acrylonitrile, methacrylonitrile, and (C₁-C₄)-alkyl esters or -cycloalkyl esters of methacrylic acid, for example methyl methacrylate, cyclohexyl methacrylate, isobornyl methacrylate and tert-butyl methacrylate.

Also suitable as other monomers are N-vinylpyrrolidone, N-(2-methacryloyloxyethyl)ethyleneurea, N-(2-acryloyloxyethyl)ethyleneurea, 2-acetoacetoxyethyl acrylate, 2-acetoacetoxyethyl methacrylate, diacetoneacrylamide.

Suitable other monomers are also monomers which impart a higher strength to the respective emulsion paints. These monomers normally have at least one epoxy group or at least two nonconjugated ethylenically unsaturated double bonds. Examples thereof include monomers having two vinyl radicals, monomers having two vinylidene radicals, and monomers having two alkenyl radicals. Particularly advantageous here are diesters of dihydric alcohols with α,β-monoethylenically unsaturated monocarboxylic acids, preference among these being given to acrylic and methacrylic acid. Examples of such monomers having two non-conjugated ethylenically unsaturated double bonds include alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates, 1,6-hexane glycol diacrylate and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, 1,6-hexane diglycol dimethacrylate and also vinyl methacrylate, vinyl acrylate, allyl methacrylate, allyl acrylate, diallyl maleate, diallyl fumarate, cyclopentadienyl acrylate, triallyl cyanurate or triallyl isocyanurate.

All monomers mentioned as other monomers can be used individually or in mixtures.

The binder polymers used according to the invention generally have minimum film-forming temperatures in the range from −5 to 30° C. Preference is given to binder polymers having a minimum film-forming temperature of 10° C., preferably ≤8° C., and particularly preferably ≤5° C.

The average particle size, determined by light scattering, of the binder polymer particles present in the polymer dispersions is preferably in the range from 50 to 300 nm, particularly preferably in the range from 50 to 200 nm.

The aqueous polymer dispersion used according to the invention is carried out by free-radical emulsion polymerization of the above-mentioned monomers in the presence of 0.01 to 1 part by weight, preferably 0.01 to 0.5 parts by weight and in particular 0.01 to 0.4 parts by weight, in each case based on the amount of total monomers, of at least one free-radical polymerization initiator.

Suitable free-radical polymerization initiators are all initiators that are capable of initiating a free-radical aqueous emulsion polymerization. These may be peroxides, hydroperoxides, e.g. alkali metal peroxodisulfates, or else azo compounds. Combined systems which are composed of at least one organic reducing agent and at least one peroxide and/or hydroperoxide are also used, for example tert-butyl hydroperoxide with the sodium salt of hydroxymethanesulfonic acid, hydrogen peroxide with ascorbic acid, or sodium peroxodisulfate with sodium disulfite. Preferred combined systems comprise in addition a small amount of a metal compound which is soluble in the polymerization medium and the metallic component of which can appear in a plurality of valence states, for example ascorbic acid/iron(II) sulfate/hydrogen peroxide, with it also frequently being possible to use, instead of ascorbic acid, the sodium salt of hydroxymethanesulfinic acid, sodium sulfite, sodium hydrogensulfite or sodium bisulfite and, instead of hydrogen peroxide, tert-butyl hydroperoxide or alkali metal peroxodisulfates and/or ammonium peroxodisulfate. Instead of a water-soluble iron(II) salt, a combination of water-soluble iron and vanadium salts is frequently used. Preferred initiators are the ammonium or alkali metal salts of peroxosulfates or peroxodisulfates, in particular sodium or potassium peroxodisulfate.

For the preparation of the polymer dispersion to be used according to the invention, in addition to the surface-active substances customary for an emulsion polymerization, at least one nonionic emulsifier is optionally used in amounts of preferably 0.5% to 10% by weight, in particular 1% to 8% by weight and particularly preferably 2% to 4% by weight, based in each case on the total monomer amount. Usable nonionic emulsifiers are aromatic or aliphatic nonionic emulsifiers, for example ethoxylated mono-, di- and trialkylphenols (EO level: 3 to 50, alkyl radical: C₄-C₉), ethoxylates of long-chain alcohols (EO level: 3 to 50, alkyl radical: C₈-C₃₆) and polyethylene oxide/polypropylene oxide block copolymers. Preference is given to using ethoxylates of long-chain alkanols (alkyl radical C₁₀-C₂₂, average degree of ethoxylation 10 to 50) and, among these, particular preference is given to using those having a linear C₁₂-C₁₈ alkyl radical and an average degree of ethoxylation of 10 to 50 as the sole nonionic emulsifiers.

Further useful emulsifiers are preferably of anionic nature. These include alkali metal and ammonium salts of alkyl sulfates (alkyl radical: C₈-C₁₂), of sulfuric monoesters of ethoxylated alkanols (EO level: 2 to 50, alkyl radical: C₁₂ to C₁₈) and of ethoxylated alkyl phenols (EO level: 3 to 50, alkyl radical: C₄-C₉), of alkylsulfonic acids (alkyl radical: C₁₂-C₁₈) and of alkylarylsulfonic acids (alkyl radical: C₉ to C₁₈).

Preferred anionic surface-active substances are also compounds of the following general formula

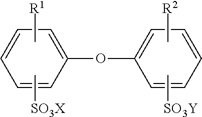

in which R¹ and R² are hydrogen or C₄-C₂₄-alkyl and are not simultaneously hydrogen, and X and Y may be alkali metal ions and/or ammonium ions. In formula I, R¹ and R² are preferably linear or branched alkyl radicals having 6 to 18 carbon atoms or hydrogen, and in particular having 6, 12 or 16 carbon atoms, where R¹ and R² are not both simultaneously hydrogen. X and Y are preferably sodium, potassium or ammonium, wherein sodium is particularly preferred. Particularly advantageous are compounds I in which X and Y are sodium, R¹ is a branched alkyl radical having 12 carbon atoms and R² is hydrogen or is identical to R¹. Frequently, technical grade mixtures comprising a proportion of 50% to 90% by weight of the monoalkylated product are used, for example Dowfax® 2A1 (trademark of Dow Chemical Company). The compounds are common knowledge, for example from U.S. Pat. No. 4,269,749, and are commercially available.

Further suitable emulsifiers can for example be found in Houben-Weyl, Methoden der organischen Chemie, volume 14/1, Makromolekulare Stoffe, Georg Thieme Verlag, Stuttgart, 1961, pp. 192 to 208.

Suitable emulsifiers are commercially available, for example under the trade names Dowfax® 2 A1, Emulan® NP 50, Dextral® OC 50, Emulgator 825, Emulgator 825 S, Emulan® OG, Texapon® NSO, Nekanil® 904 S, Lumiten® I-RA, Lumiten® I-SC, Lumiten® E 3065, Disponil® FES 77, Lutensol® AT 18, Steinapol® VSL, Emulphor® NPS 25.

In addition, it is possible to use suitable protective colloids, such as for example polyvinyl alcohols, cellulose derivatives or vinylpyrrolidone-comprising copolymers. A detailed description of further suitable protective colloids can be found in Houben-Weyl, Methoden der Organischen Chemie, vol. 14/1, Makromolekulare Stoffe, Georg-Thieme-Verlag, Stuttgart, 1961, pp. 411-420. The total amount of surface-active substances (solid) typically constitutes up to 30% by weight, preferably 0.3% to 10% by weight and particularly preferably 0.5% to 5% by weight, based on the monomers to be polymerized.

The molecular weight of the binder polymers can be adjusted by the addition of small amounts, generally up to 2% by weight, based on the monomers to be polymerized, of one or more molecular weight-regulating substances, for example organic thio compounds or allyl alcohols. However, preference is given to those binder polymers which have been prepared in the absence of such compounds.

The emulsion polymerization can be effected either continuously or in a batchwise mode, preferably by a semicontinuous process. In this case, the monomers to be polymerized can be added continuously, including staged or gradient modes, to the polymerization mixture. Preference is given to a feed method having short feed times, that is to say that the monomers are metered into the reaction mixture, preferably as an aqueous emulsion, within 1 to 4 hours, preferably within 1.5 to 3 hours.

As well as the seed-free mode of preparation, the polymer particle size can also be adjusted by effecting the emulsion polymerization by the seed latex process or in the presence of a seed latex produced in situ. Such processes are known and can be found in the prior art (see EP-B 40 419 and ‘Encyclopedia of Polymer Science and Technology’, vol. 5, John Wiley & Sons Inc., New York, 1966, p. 847).

For instance, in the feed method, the prior art recommends initially charging the polymerization vessel with a defined, finely divided seed polymer dispersion and then polymerizing the monomers in the presence of the seed. In this case, the seed polymer particles act as ‘polymerization nuclei’ and decouple the polymer particle formation and polymer particle growth. Further seed dispersion can be added during the emulsion polymerization. This achieves broad size distributions of the polymer particles, which are often desirable especially in the case of polymer dispersions having a high solids content (cf. DE-A 42 13 965). Rather than the addition of a defined seed latex, it can also be produced in situ. For this purpose, for example, a portion of the monomers and of the initiator together with emulsifier is initially charged and heated to reaction temperature to form a relatively finely divided latex. The actual polymerization is then carried out by the feed method in the same polymerization vessel (see also DE-A 42 13 965).

The manner in which the initiator of the emulsion polymerization is metered in is not critical. The initiator can either be entirely initially charged in the polymerization vessel or be added continuously or in stages at the rate of its consumption over the course of the emulsion polymerization. The procedure depends both on the chemical nature of the initiator and on the polymerization temperature and can be chosen by the person skilled in the art according to requirements. A continuous or step-wise metered addition to the reaction mixture is preferred.

The polymerization pressure and polymerization temperature are likewise of minor importance. In general, temperatures between room temperature and 120° C., preferably temperatures of 50 to 95° C. and particularly preferably between 70 and 90° C., are used.

Following the actual polymerization reaction, it is generally necessary to render the aqueous polymer dispersion largely free from odor carriers such as residual monomers and other volatile organic constituents. This can be achieved in a manner known per se by physical means by distillative removal (in particular via steam distillation) or by stripping with an inert gas.

The reduction in residual monomers can also be effected by chemical means by free-radical postpolymerization, in particular under the action of redox initiator systems, such as are detailed for example in DE-A 44 35 423, DE-A 44 19 518 and also in DE-A 44 35 422. Particularly suitable oxidizing agents for the redox-initiated postpolymerization include hydrogen peroxide, tert-butyl hydroperoxide, cumene hydroperoxide or alkali metal peroxide sulfates. Suitable reducing agents include sodium disulfite, sodium hydrogensulfite, sodium dithionite, sodium hydroxymethanesulfinate, formamidinesulfinic acid, acetone bisulfite (=addition product of sodium hydrogensulfite onto acetone), ascorbic acid or reducing sugar compounds, or water-soluble mercaptans such as mercaptoethanol. The postpolymerization with the redox initiator system is conducted in the temperature range from 10 to 100° C., preferably at 20 to 90° C. The redox partners can each independently be added to the dispersion in their entirety, in portions or continuously over a period of 10 minutes to 4 hours. To improve the postpolymerization action of the redox initiator systems, soluble salts of metals of varying valency, such as iron, copper or vanadium salts, may be added to the dispersion. Complexing agents which keep the metal salts in solution under the reaction conditions are also frequently added.

The polymer dispersion is usually finally neutralized with a base, such as alkali metal or alkaline earth metal hydroxides, alkaline earth metal oxides or volatile or nonvolatile amines. Nonvolatile amines include in particular ethoxylated diamines or polyamines, such as are commercially available for example under the name Jeffamine® (Texaco Chemical Co.). Polymer dispersions prepared by this method are generally known.

Such polymer dispersions can then, together with alkali metal alkylsiliconate and/or water-soluble silicate, be adjusted to a pH in the range from 10 to 12, preferably 11 to 12. According to one embodiment according to the invention, the pH can be adjusted when formulating the emulsion paint according to the invention.

The present invention thus also relates to the use of an aqueous polymer dispersion having a solids content in the range from 40% to 60% by weight, obtainable by the free-radical aqueous emulsion polymerization of a monomer mixture comprising ethylhexyl acrylate, butyl acrylate and one or more vinylaromatics, as an organic binder, in combination with an alkali metal alkylsiliconate and/or water-soluble silicate in a coating composition, preferably an emulsion paint, having a pH in the range from 10 to 12.

It is, however, also possible to already adjust the polymer dispersion to a pH in the range from 10 to 12, preferably 11 to 12, by addition of alkali metal alkylsiliconate and/or water-soluble silicates and optionally inorganic base. Suitable inorganic bases are the above-mentioned alkali metal or alkaline earth metal hydroxides and alkaline earth metal oxides. Addition can be carried out in any order here.

The present invention thus also relates to aqueous polymer dispersions obtainable by the free-radical aqueous emulsion polymerization of a monomer mixture comprising ethylhexyl acrylate, butyl acrylate and one or more vinylaromatics, preferably styrene, and subsequent adjustment of the pH to a value in the range from 10 to 12 with at least 0.5% by weight of alkali metal alkylsiliconate and/or water-soluble silicates, based on the aqueous polymer dispersion, and optionally with an inorganic base.

Aqueous polymer dispersions are preferably obtainable by the free-radical aqueous emulsion polymerization of a monomer mixture comprising 10 to 30 parts by weight, based on the total monomers, of ethylhexyl acrylate, 25 to 50 parts by weight, based on the total monomers, of butyl acrylate, and 30 to 50 parts by weight, based on the total monomers, of one or more vinylaromatics, preferably styrene, and optionally up to 10% by weight of further ethylenically unsaturated monomers, wherein the sum total of all monomers amounts to 100% by weight parts, polymerized, and subsequent adjustment of the pH to a value in the range from 10 to 12 with at least 0.5, preferably with 0.5 to 10% by weight of alkali metal alkylsiliconate and/or water-soluble silicates, based on the aqueous polymer dispersion, and optionally with an inorganic base.

Particular preference is given to the above-mentioned polymer dispersions, which are obtained by free-radical aqueous emulsion polymerization and are subsequently adjusted to a pH in the range from 10 to 12 with at least 0.5, preferably with 0.5 to 10% by weight of alkali metal alkylsiliconate and/or water-soluble silicates, based on the aqueous polymer dispersion, and optionally with an inorganic base.

The present invention thus also relates to a process for preparing an aqueous polymer dispersion, in which a monomer mixture comprising ethylhexyl acrylate, butyl acrylate and one or more vinylaromatics, preferably styrene, is free-radically polymerized and then the pH of the dispersion obtained thereafter is adjusted to a value in the range from 10 to 12 with alkali metal alkylsiliconate and/or a water-soluble silicate and optionally an inorganic base.

Alkali metal alkylsiliconates according to the invention are in particular compounds having the formula MOSi(R)(OH)z, where M is an alkali metal and R is an alkyl radical. Alkali metal alkylsiliconates can for example be obtained by reacting alkylsilanetriol with an alkali metal hydroxide. The production of solutions of alkali metal alkylsiliconates, in particular aqueous solutions, is described for example in DE 1 031 910.

In the compounds MOSi(R)(OH)z which are suitable for the alkali metal alkylsiliconate according to the invention, the alkali metal M can in particular be selected from the group consisting of lithium, sodium, potassium and mixtures thereof. The alkyl radical R is preferably selected from the group consisting of methyl, ethyl, n-propyl, isopropyl, n-butyl, isobutyl, tert-butyl, n-pentyl, isopentyl, tert-pentyl, neopentyl, phenyl, aryl, and cyclohexyl.

Preference is given to the alkyl radical methyl. The alkali metal alkylsiliconate of the emulsion paint according to the invention is further preferably selected from the group consisting of lithium methylsiliconate, sodium methylsiliconate and potassium methylsiliconate. The alkali metal alkylsiliconate is most preferably potassium methylsiliconate. These alkali metal alkylsiliconates, in particular potassium methylsiliconate, result in homogeneous surfaces and are easy to handle.

The alkali metal alkylsiliconate is present in the emulsion paint according to the invention in an amount of 0.1% to 5% by weight, based on the total weight of the emulsion paint. The emulsion paint according to the invention preferably comprises 0.1% to 2% by weight, in particular 0.3% to 2% by weight or 0.5% to 1.5% by weight, of alkali metal alkylsiliconate, based in each case on the total weight of the emulsion paint. Emulsion paints with these contents display good processibility and a good storage stability.

The water-soluble alkali metal silicate is present in the emulsion paint according to the invention in an amount of 0.1% to 5% by weight (solid), based on the total weight of the emulsion paint. Based on the SiO₂ content, the proportion of water-soluble alkali metal silicates in the emulsion paint is preferably 0.06% to 3.3% by weight, calculated as silicon dioxide.

Water-soluble silicates suitable according to the invention are water-soluble alkali metal silicates, also referred to as waterglass, such as lithium, sodium or preferably potassium silicate (potassium waterglass). A potassium waterglass having a K₂O content (ISO 1692) in the range from 5% to 15% by weight, preferably 7% to 12% by weight, and an SiO₂ content (in accordance with ISO 2124) in the range from 15%-30% by weight, is particularly preferably used in the aqueous solution.

The aqueous polymer dispersions according to the invention are preferably suitable for the formulation of emulsion paints, in particular of interior paints, having a pigment volume concentration of 50, preferably 60 to 90.

According to the invention, the emulsion paints also comprise 20% to 70% by weight of inorganic fillers. Examples of suitable fillers are aluminosilicates such as feldspars, silicates such as kaolin, talc, mica, magnesite, alkaline earth metal carbonates such as calcium carbonate, for example in the form of calcite or chalk, magnesium carbonate, dolomite, alkaline earth metal sulfates such as calcium sulfate, silicon dioxide, etc. In paints, preference is naturally given to finely divided fillers. The fillers may be used in the form of individual components. In practice, however, filler mixtures have been found to be particularly useful, for example calcium carbonate/kaolin, calcium carbonate/talc.

Finely divided fillers may also be employed to enhance hiding power and/or to economize on white pigments. Blends of color pigments and fillers are preferably used to control the hiding power of the hue and the depth of color.

The emulsion paints can also comprise up to 30% by weight of at least one pigment. Suitable pigments are, for example, inorganic white pigments such as titanium dioxide, preferably in the rutile form, barium sulfate, zinc oxide, zinc sulfide, basic lead carbonate, antimony trioxide, lithopone (zinc sulfide+barium sulfate), or colored pigments, for example iron oxides, carbon black, graphite, zinc yellow, zinc green, ultramarine, manganese black, antimony black, manganese violet, Prussian blue or Paris green. In addition to the inorganic pigments, the emulsion paints according to the invention may also comprise organic color pigments, for example sepia, gamBoge, Cassel brown, toluidine red, para red, Hansa yellow, indigo, azo dyes, anthraquinoid and indigoid dyes and also dioxazine, quinacridone, phthalocyanine, isoindolinone and metal complex pigments. Also suitable are synthetic white pigments with air inclusions to enhance light scattering, such as the Ropaque® dispersions.

The emulsion paints also comprise 0.1% to 10% by weight of further auxiliaries such as are customary in emulsion paints based on aqueous polymer dispersions. Typical auxiliaries include, in addition to the emulsifiers employed in the polymerization, wetting agents or dispersants, such as sodium, potassium or ammonium polyphosphates, alkali metal and ammonium salts of acrylic or maleic anhydride copolymers, polyphosphonates, such as sodium 1-hydroxyethane-1,1-diphosphonate and the salts of naphthalenesulfonic acids, in particular the sodium salts thereof.

Further suitable auxiliaries are leveling agents, defoamers, biocides and thickeners. Suitable thickeners are, for example, associative thickeners, such as polyurethane thickeners. The amount of thickener is preferably less than 1% by weight, particularly preferably less than 0.6% by weight, based on the solids content of the emulsion paint.

The PVC describes the ratio of the volume of pigments (V_{P}) and fillers (V_{F}) relative to the total volume, consisting of the volumes of binder (V_{B}), pigments and fillers in a dried coating film in percent: PVC=(V_{P}+V_{F})×100/(V_{P}+V_{F}+V_{B}) (cf. Ullmann's Enzyklopädie der technischen Chemie, 4th edition, volume 15, p. 667).

Particular preference is given to aqueous emulsion paints comprising
a) 5% to 30% by weight, preferably 8% to 15% by weight, of the aqueous polymer dispersion having a solids content in the range from 40% to 60% by weight,
b) 0.1% to 3.5% by weight, preferably 0.2% to 2% by weight, of alkali metal alkylsiliconate and/or water-soluble silicate, preferably 0.3% to 1.5% by weight of potassium alkylsiliconate,
c) 20% to 70% by weight, preferably 30% to 60% by weight, of inorganic fillers,
d) 0% to 30% by weight, preferably 0% to 20% by weight, of at least one inorganic pigment,
e) 0.1% to 10% by weight of customary auxiliaries, and
f) water,
   based in each case on the total amount of the emulsion paint, the pH of the emulsion paint having a value in the range from 10 to 12, preferably 11 to 12.

The present invention further provides for the use of an aqueous polymer dispersion, as defined above, in emulsion paints, preferably for interior paints having a high filler content.

The emulsion paints according to the invention having a pH exhibit a good pH stability, meaning that they are not, or are only slightly, susceptible to attack by microorganisms. This very good stability makes it readily possible to create formulations without, or with much lower amounts of, preservatives and/or biocides.

The same also applies to the novel dispersions according to the invention, which have been set to a pH of 10 to 12, preferably 11 to 12, with the alkali metal alkylsiliconate and/or water-soluble silicate and optionally an alkaline base. They also exhibit a good pH stability and do not have a tendency to attack by microorganisms.

The dispersions according to the invention also do not form any coagulate at high pH. Coagulates generally lead to filtration problems. Dispersions with coagulate or a tendency to coagulate are typically also problematic in use.

The examples given below are intended to elucidate the invention without, however, limiting it.

The particle size (Z-average) of the polymer particles was determined by dynamic light scattering on a 0.01% by weight dispersion at 23° C. using an Autosizer IIc from Malvern Instruments, England. What is reported is the cumulant z-average diameter of the measured autocorrelation function.

The pH was determined using a Knick (model: Portamess 913(X) ph) pH meter.

Solids contents of the polymer dispersions were determined by distributing 0.5 to 1.5 g of the polymer dispersion in a 4 cm diameter sheet metal lid and then drying same at 140° C. to constant mass using a dryer (Mettler Toledo HR 83 halogen dryer). The ratio of the mass of the sample after drying to the mass of the sample when it was taken gives the solids content of the polymer.

The viscosity was determined by two different methods:

ICI: is measured using an I.C.I. Cone & Plate viscometer from Epprecht Instruments & Controls AG and given in the unit poise [P]

KU: is measured using a Brookfield viscometer (from Brookfield) at 200 rpm and given in Krebs units [KU]

Investigation of the polymer dispersion in respect of stability against coagulate formation:

A stored dispersion was applied thinly to a glass plate (using a glass rod) and the defects were assessed visually (specks/grit). The less formation of specks or grit over the storage period, the lower the tendency to coagulate of the dispersion and the more stable the colloidal stability of the dispersion.

General Procedure for Preparing the Polymer Dispersion:

Polymer dispersions were prepared by means of semi-continuous emulsion polymerization. This involved controlling the particle sizes using a polystyrene seed in the initial charge in the reactor and adjusting same to 100-300 nm. The ratios of the monomers used are collated in table 1. The water distribution was selected so that the theoretical solids content of the fully polymerized dispersion was at the values given in table 1.

### EXAMPLES E1 AND E2 AND COMPARATIVE EXAMPLES C1, C2 AND C3

The dispersions E1 and E2 according to the invention and the comparative dispersions C1, C2 and C3 not in accordance with the invention were prepared using the monomers indicated in table 1 and in the indicated amounts in accordance with the general procedure for preparing the polymer dispersion.

TABLE 1
Monomer composition of the dispersions

| Dispersion | C1 | E1 | E2 | C2 | C3 |
|---|---|---|---|---|---|
| acrylic acid [pphm] | 2.7 | 1.7 | 1.5 | 1.2 | 1.5 |
| acrylamide [pphm] | 1.5 | — | — | — | — |
| n-butyl acrylate | 49.8 | 39.8 | 39.8 | — | — |
| [pphm] | | | | | |
| ethylhexyl acrylate | — | 15.7 | 15.7 | 49.6 | 49.8 |
| [pphm] | | | | | |
| styrene [pphm] | 46 | 42.6 | 42.8 | 49 | 48.7 |
| 3-methacryloxy- | — | 0.2 | 0.2 | 0.2 | — |
| propyltrimethoxy- | | | | | |
| silane [pphm] | | | | | |
| theoretical solids | 50 | 50 | 50 | 50 | 50 |
| content [%] | | | | | |

pphm: parts per hundred monomer

The reaction product is then admixed with the aid of a base at reaction or room temperature, the pH being adjusted to >11 in the process. The precise conditions for adjusting the pH can be found in the individual examples.

Preparation of the Dispersion D1C1, D2E1, D3E2, D4C2 and D5C3 by Aftertreatment

The aftertreatment was effected in accordance with the data found in table 2. First, C1, E1 and E2 were neutralized (pH 7) using sodium hydroxide solution. Then, 10 g of SILRES® BS 16 were added to 400 g of the dispersion thus adjusted. If necessary, 20% by weight potassium hydroxide solution was then used to adjust the dispersion to a pH >11 (see pH immediately, table 2).

TABLE 2
Preparation of the aftertreated dispersions:

| Exam- | Disper- | | pH | pH after |
|---|---|---|---|---|
| ple | sion | Adjustment of the pH using | immediately | 24 h |
| D1C1 | C1 | potassium methylsiliconate | 11.3 | 11.1 |
| | | potassium hydroxide solution | | |
| D2E1 | E1 | potassium methylsiliconate | 11.1 | 11.4 |
| D3E2 | E2 | potassium methylsiliconate | 11.1 | 11.3 |

The potassium methylsiliconate used was SILRES® BS 16.

Silres BS16 (from Wacker, solids content 55% by weight)

The dispersions were stored under various conditions. After varying storage times, the properties of the dispersion were examined. The results are collated in table 3.

TABLE 3
pH after storage

| Time of measurement | D1C1 | D2E1 | D3E2 |
|---|---|---|---|
| 7 days, 25° C. | 10.8 | 11.3 | 11.5 |
| 7 days, 50° C. | 10.6 | 11.1 | 11.4 |
| 14 days, 50° C. | 10.5 | 11.2 | |

The measurement results show that in the case of the dispersion D2E1 prepared in accordance with the invention, the pH is maintained even over a relatively long storage and does not weaken. For dispersions where the pH drops below a value of 11, a more intense attack from microorganisms can generally be expected. The drop in the pH can already be seen as a trend in the storage of the sample D1C1. The dispersions D2E1 according to the invention thus exhibit a better storage stability.

Preparation of the Dispersions D6E1 and D7E2 by Aftertreatment (According to the Invention)

The aftertreatment was effected in accordance with the data found in table 2. To this end, the reaction products E1 and E2 were first neutralized (pH 7) using sodium hydroxide solution and then admixed with Trasol® KH-K (potassium waterglass, from BASF) in a mass ratio of 80 to 20 (polymer dispersion/Trasol KW-K) with stirring, and homogenized. The values reported in table 4 resulted for the pH

TABLE 4
pH of the aftertreated dispersions:

| Example | Dispersion | Adjustment of the pH using | pH |
|---|---|---|---|
| D6E1 | E1 | potassium waterglass | 11.3 |
| D7E2 | E2 | potassium waterglass | 11.3 |

Trasol® KH-K (potassium waterglass, solids content 30-40%, K₂O content (ISO 1692): 10.5-11.2%; SiO₂ content (in accordance with ISO 2124): 23.4-24.4)

The dispersions were stored under various conditions. After varying storage times, the properties of the dispersion were examined. The results are collated in table 5.

TABLE 5
pH after storage

| Time of measurement | D6E1 | D7E2 |
|---|---|---|
| pH immediately after | 11.3 | 11.3 |
| preparation | | |
| pH after 14 days | 11.3 | 11.3 |
| pH after 28 days | 11.2 | 11.2 |
| pH after 5 months | 11.3 | 11.3 |
| Viscosity after storage | Liquid, no visible | Liquid, no visible |
| for 7 days at 50° C. | change in viscosity | change in viscosity |

A sample of each stored dispersion was thinly applied to a glass plate using a glass rod and assessed for visual defects.

TABLE 6
Coagulate formation after storage of dispersions D6E1 and D7E2

| Duration of storage | D6E1 | D7E2 |
|---|---|---|
| Without storage | no coagulate | no coagulate |
| Assessment | Ok | Ok |
| 14 days | no coagulate | minimal grit |
| Assessment | Ok | Ok |
| 5 months | no coagulate | minimal grit |
| Assessment | Ok | Ok |

It becomes clear from the examples described that dispersions prepared by the claimed process are very stable towards a high pH. This can be seen from the fact that the physical properties such as pH, viscosity or stability (coagulate formation) are very constant.

Further investigations were performed. E1 and C3 were neutralized (pH 7) using sodium hydroxide solution and then admixed with Trasol® KW-N (potassium waterglass having a solids content of 28%) in the mass ratio 80 to 20 (polymer dispersion/Trasol KW-N) with stirring, and homogenized. This affords dispersions D8E1 and D9C3 having an initial pH of 10.9. Both dispersions have a low viscosity and are free-flowing. Stability investigations were once again carried out. After one day of storage at 50° C., dispersion D9C3 became much thicker, meaning that no further investigations were possible, whereas D8E1 still has the same pH of 10.9 and a low viscosity (no visible change from the initial state) even after storage for 14 days at 50° C.

Emulsion Paint P1 (According to the Invention)

An emulsion paint having the following compositions was prepared:

| | P1 |
|---|---|
| Water | 384.0 |
| Tylose ® H 6000 YP 2 (cellulose ether) | 6.0 |
| Dispex AA 4140 (dispersant) | 5.0 |
| Calgon N | 5.0 |
| 10% by weight potassium hydroxide solution | 1.0 |
| Agitan 260 (defoamer) | 4.0 |
| TiO₂ | 100.0 |
| Aluminum silicate, precipitated | 229.4 |
| Talc | 51.3 |
| Non-neutralized E1 (pH = 2) | 115.5 |
| SILRES BS16 | 7.2 |
| Water | 59.6 |
| Agitan 260 | 5.0 |
| | 1000.0 |

The above formulation has a solids content of 48.9% by weight and a PVC of 71.7. The paint has a pH of 10 after preparation and was adjusted to a pH of 11.3 with 20% by weight potassium hydroxide solution.

Alternatively, the dispersion D2E1, which has been adjusted to pH >11 with potassium methylsiliconate and potassium hydroxide solution, can be used as binder in the formulation as a paint, and exhibits a stable pH after storage.

TABLE 7
Stability investigations on paint formulation P1:

| | | Viscosity | Viscosity |
|---|---|---|---|
| Duration of storage | pH | KU | ICl (cone C) |
| None (directly | 11.3 | 102 | 1.5 |
| after formulation) | | | |
| 24 h at RT | 11.4 | | |
| 7 days at RT | 11.1 | | |
| 14 days at RT | 11.1 | 108 | 1.6 |
| 14 days at 50° C. | — | 106 | 1.5 |

RT: room temperature, 25° C.

The dispersion paint displays very good stability in terms of viscosity and pH.

1.-13. (canceled)

14. An aqueous emulsion paint comprising
a) 5% to 50% by weight of an aqueous polymer dispersion having a solids content in the range from 40% to 60% by weight, obtainable by the free-radical aqueous emulsion polymerization of a monomer mixture comprising ethylhexyl acrylate, butyl acrylate and one or more vinylaromatics,
b) 0.1% to 5% by weight of alkali metal alkylsiliconate and/or water-soluble silicate,
c) 20% to 70% by weight of inorganic fillers,
d) 0% to 30% by weight of at least one inorganic pigment,
e) 0.1% to 10% by weight of customary auxiliaries, and
f) water,
based in each case on the total amount of the emulsion paint, the pH of the emulsion paint having a value in the range from 10 to 12.

15. The aqueous emulsion paint according to claim 14, wherein the monomer mixture comprises
10 to 30 parts by weight, based on the total monomers, of ethylhexyl acrylate,
25 to 50 parts by weight, based on the total monomers, of butyl acrylate and
30 to 50 parts by weight, based on the total monomers, of one or more vinylaromatics.

16. The aqueous emulsion paint according to claim 14, wherein the monomer mixture comprises 0.1 to 5 parts by weight, based on the total monomers, of one or more monomers selected from among sulfonic acids, carboxylic acids, the alkali metal or ammonium salts thereof, carboxylic anhydrides, amides and hydroxyalkyl esters.

17. The aqueous emulsion paint according to claim 14, wherein the monomer mixture comprises 0.01 to 5 parts by weight, based on the total monomers, of monomers comprising siloxane groups.

18. The aqueous emulsion paint according to claim 14, wherein the binder polymer which is obtained by free-radical aqueous emulsion polymerization has a minimum film-forming temperature in the range from −5 to 30° C.

19. The aqueous emulsion paint according to claim 14, wherein the binder polymer particles present in the polymer dispersion have an average particle size in the range from 50 to 300 nm.

20. The aqueous emulsion paint according to claim 14, wherein the proportion of water-soluble silicate is 0.06% to 3.3% by weight, calculated as silicon dioxide.

21. The aqueous emulsion paint according to claim 14, which has a pigment volume concentration in the range from 60 to 90.

22. A coating composition comprising a aqueous polymer dispersion having a solids content in the range from 40% to 60% by weight, obtainable by the free-radical aqueous emulsion polymerization of a monomer mixture comprising ethylhexyl acrylate, butyl acrylate and one or more vinylaromatics, as an organic binder, in combination with an alkali metal alkylsiliconate and/or water-soluble silicate.

23. The coating composition as claimed in claim 22, wherein the composition has a pH in the range from 10 to 12

24. An aqueous polymer dispersion obtainable by the free-radical aqueous emulsion polymerization of a monomer mixture comprising ethylhexyl acrylate, butyl acrylate and one or more vinylaromatics,
and subsequent adjustment of the pH to a value in the range from 10 to 12 with at least 0.5% by weight of alkali metal alkylsiliconate and/or water-soluble silicates, based on the aqueous polymer dispersion, and optionally with an inorganic base.

25. The aqueous polymer dispersion according to claim 24, wherein said one or more vinylaromatics are styrene.

26. The aqueous polymer dispersion according to claim 24, wherein a monomer mixture comprising:
10 to 30 parts by weight of ethylhexyl acrylate,
25 to 50 parts by weight of butyl acrylate,
30 to 50 parts by weight of one or more vinylaromatics,
0 to 10 parts by weight of one or more monomers selected from among sulfonic acids, carboxylic acids, the alkali metal or ammonium salts thereof, carboxylic anhydrides, amides and hydroxyalkyl esters,
0 to 5 parts by weight of monomers comprising siloxane groups and
0 to 10 parts by weight of other monomers,
based in each case on the total monomers, is polymerized.

27. The aqueous polymer dispersion according to claim 24, wherein a monomer mixture comprising
10 to 30 parts by weight of ethylhexyl acrylate,
25 to 50 parts by weight of butyl acrylate,
30 to 50 parts by weight of one or more vinylaromatics,
0.01 to 5 parts by weight of monomers comprising siloxane groups and
optionally up to 10% by weight of other monomers,
based in each case on the total monomers, is polymerized.

28. The aqueous polymer dispersion according to claim 24, wherein a monomer mixture comprising
10 to 30 parts by weight of ethylhexyl acrylate,
25 to 50 parts by weight of butyl acrylate,
30 to 50 parts by weight of styrene,
0.01 to 5 parts by weight of monomers comprising siloxane groups and
optionally up to 10% by weight of other monomers,
based in each case on the total monomers, is polymerized.

29. A process for preparing an aqueous polymer dispersion according to claim 24, which comprises free-radically polymerizing the monomer mixture comprising ethylhexyl acrylate, butyl acrylate and one or more vinylaromatics and then adjusting the pH of the dispersion obtained to a value in the range from 10 to 12 with alkali metal alkylsiliconate and/or a water-soluble silicate and optionally an inorganic base.
